(19) United States
(12) Patent Application Publication
(10) Pub. No.: US 2011/0274924 A1
(43) Pub. Date: Nov. 10, 2011

(54) MID-INFRARED TRANSMITTING FIBER

(75) Inventors: SHIBIN JIANG, TUCSON, AZ (US); TAO LUO, TUCSON, AZ (US)

(73) Assignee: ADVALUE PHOTONICS, INC., TUCSON, AZ (US)

(21) Appl. No.: 12/774,676

(22) Filed: May 5, 2010

(51) Int. Cl. B32B 17/02

(52) U.S. Cl. 428/375

(57) ABSTRACT

A mid-infrared transmitting glass fiber comprising a non-oxide infrared transmitting glass core, and an oxide glass external cladding. In certain embodiments, the non-oxide infrared transmitting glass core comprises chalcogenide glass. In certain embodiments, the mid-infrared transmitting glass fiber further comprises a non-oxide infrared transmitting glass inner cladding.

### FIELD OF THE INVENTION

Various implementations, and combinations thereof, are related to mid-infrared transmitting fibers and, more particularly, to mid-infrared transmitting glass fibers that are mechanically strong.

### BACKGROUND OF THE INVENTION

Optical fibers for mid-infrared transmission from 1-20 microns are desirable for a wide variety of applications such as infrared countermeasure (IRCM) systems, chemical and temperature sensing, laser delivery medium, and lightguide delivery cable for spectroscopy. However, such fibers are expensive, brittle, and fragile, limiting their practical application. While significant effort has been devoted to developing infrared fibers that are both physically strong and have a low propagation loss, little progress has been made due to the inherent characteristics of a mid-infrared transmissive fiber. The absorption of a solid in the long-wavelength limit is determined by the multiphonon, or IR (infrared), absorption edge and arises from inner molecule or lattice vibrations. A simple Hooke's law mass-on-spring model predicts that the multiphonon absorption edge shifts towards longer wavelengths when heavier atoms are incorporated into the glass network or when chemical bonds are weakened. As will be appreciated by one of ordinary skill in the art, to push the infrared absorption edge toward longer wavelengths, the forces of attraction between ions should be low, i.e., the mass of the ions should be high, meaning that that glass that is strongly transmissive in the mid-infrared range is inherently physically weak. While the most commonly used fiber for mid-infrared applications is chalcogenide glass fiber due to its low propagation loss, it is also physically weak, making it extremely difficult to use for fiber optical cable assembling and restricting its practical use.

### SUMMARY OF THE INVENTION

In one implementation, a mid-infrared transmitting glass fiber is presented wherein the mid-infrared transmitting glass fiber comprises a non-oxide infrared transmitting glass core and an oxide glass cladding.

In another implementation, a mid-infrared transmitting glass fiber is presented wherein the mid-infrared transmitting glass fiber comprises a non-oxide infrared transmitting glass core, a non-oxide infrared transmitting glass inner cladding, and an oxide glass external cladding.

### BRIEF DESCRIPTION OF THE DRAWINGS

Implementations of the invention will become more apparent from the detailed description set forth below when taken in conjunction with the drawings, in which like elements bear like reference numerals.

FIG. 1 is an exemplary diagram of the cross section and refractive index of Applicants' hybrid fiber;

FIG. 2 is a schematic of an exemplary fiber preform for Applicants' hybrid fiber; and

FIG. 3 is an exemplary schematic of a purification process to purify the core and inner cladding glasses used in Applicants' hybrid fiber.

### DETAILED DESCRIPTION OF THE PREFERRED EMBODIMENTS

Implementations propose a hybrid fiber that is both transmissive in the mid-infrared range and mechanically strong. By mechanically strong, Applicants refer to either tensile or flexion strength. As will be known to one of ordinary skill in the art, infrared radiation is electromagnetic radiation with a wavelength between 0.7 and 300 microns. Generally, the infrared range is divided into 3 spectral regions: near, mid, and far-infrared, however the boundaries between the spectral regions are not universally agreed upon and can vary. As used herein, the mid-infrared range will be considered from 1˜20 microns.

Throughout the following description, this invention is described in preferred embodiments with reference to the figures in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment, “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

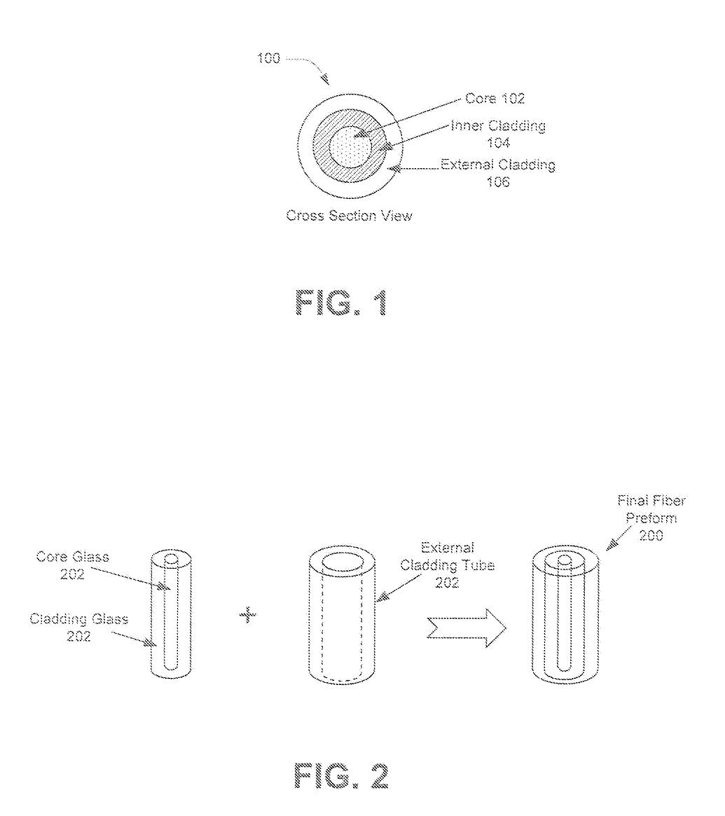

FIG. 1 presents an exemplary schematic of the cross section 100 of Applicants' hybrid fiber that is both transmissive in the mid-infrared range and mechanically strong. Core 102 and inner cladding 104 of cross section 100 are glass materials with high infrared transmission, such as chalcogenide glass and fluoride glass. As will be known to one of ordinary skill in the art, chalcogenide glasses are composed of one or more chalcogenide elements as a substantial constituent, where the chalcogenide element is commonly selected from the group arsenic (As), germanium (Ge), antimony (Sb), phosphorus (P), tellurium (Te), selenium (Se), and sulfur (S). External cladding 106 is an oxide glass exhibiting good mechanical strength, such as, and without limitation, silicate glass, phosphate glass, germanate glass, tellurite glass, borate glass, aluminate glass, and bismuth glass. In certain embodiments, external cladding 106 is silicate glass exhibiting high mechanical strength and having a relatively low softening temperature. In certain embodiments, the index of refraction of core 102 is higher than the index of refraction of inner cladding 104. Typically the refractive index of the external cladding 106 is lower than the inner cladding 104.

Oxide glasses exhibit much higher mechanical strength than non-oxide glasses such as chalcogenide glasses and fluoride glasses. By non-oxide Applicants refer to glasses containing less than 2 weight % of oxide materials. Non-oxide glasses include, but are not limited to, chalcogenide glasses and fluoride glasses.

The glass network former in silicate glasses is SiO₂ and the bond strength of Si—O is much stronger than the bond strength of As—S, As—Se, Ge—S, Ge—Se, Te—Se, and Te—As. The mechanical strength of a fiber can be determined as either tensile strength or bending strength, which is linearly proportional to Young's modulus, the measure of the stiffness of an isotropic elastic material. The Young's modulus of arsenic trisulfide, As₂S₃, glass is 18 GPa while most silicate glasses are between 70-90 GPa. Thus, typically silicate glass fibers are more than four (4) times stronger than As₂S₃ glass fiber, one of the strongest chalcogenide glass fibers.

The mechanical strength of Applicants' hybrid fiber is further increased due to the large cross section area of external cladding 106. Table 1 below shows the cross section areas of core, inner cladding, and external cladding for three different fibers with various core, inner cladding, and external cladding diameters. The inner cladding diameter is adjusted to ensure the beam propagating in the core of the fiber will not reach the external cladding. As can be seen in Table 1, the cross section area of the external cladding dominates the area of the total fiber cross section. As the mechanical strength of glass fiber is mainly determined by the cross section area, in certain embodiments the mechanical strength of Applicants' hybrid fiber is twice that of As₂S₃ glass fiber.

TABLE 1
Cross section diameters and areas for different hybrid fibers.

| | | | | | | | | External |
|---|---|---|---|---|---|---|---|---|
| | | | | | | | Total fiber | Cladding |
| | Core | | Inner Cladding | | External Cladding | | cross | Cross |
| | Diameter | Area | Diameter | Area | Diameter | Area | section | Section |
| | (μm) | (μm²) | (μm) | (μm²) | (μm) | (μm²) | area (μm²) | Area (%) |
| Multimode | 50 | 1963 | 80 | 3061 | 125 | 7242 | 12266 | 59% |
| Fiber 1 | | | | | | | | |
| Multimode | 50 | 1963 | 80 | 3061 | 200 | 26376 | 31400 | 84% |
| Fiber 2 | | | | | | | | |
| Multimode | 60 | 2826 | 90 | 3533 | 200 | 25042 | 31400 | 80% |
| Fiber 3 | | | | | | | | |

In certain embodiments, the cross section area of the external cladding is between five percent (5%) and ninety-five percent (95%) of a total cross section area of the multicomponent glass fiber. In certain embodiments, it is preferable that the cross section area of the external cladding is between thirty percent (30%) and eighty-five percent (85%).

It should be noted that the coefficient of thermal expansion (CTE) of chalcogenide glass is very different than silicate glass. The typical CTE of chalcogenide glass and silicate glass are around 250×10⁻⁷° C.⁻1 (one over degree Celsius) and 100×10⁻⁷° C.⁻1 (one over degree Celsius), respectively. During the fiber drawing process when the fiber is cooling from the softening temperature to room temperature, strong contraction will occur because of the relatively larger CTE of chalcogenide glass compared to the silicate glass. This strong contraction results in compression stress in the external cladding layer and further increases the mechanical strength of the fiber.

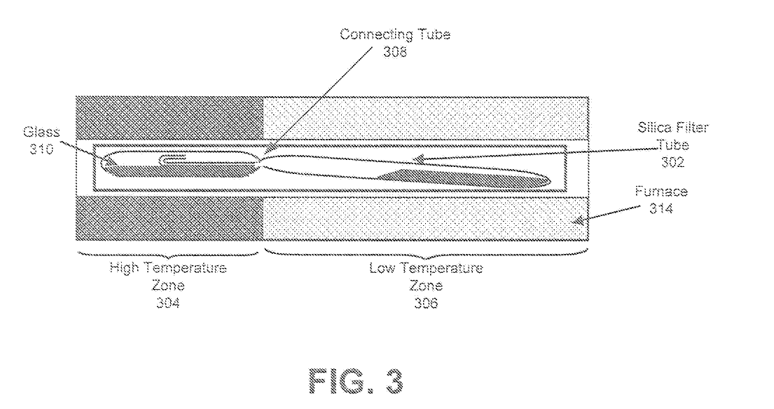

Purification of core glass 102 and inner cladding glass 104 is important to achieve low attenuation. In the preferred method, high-purity glasses for core glass 102 and inner cladding glass 104 will be prepared from 6N purity starting elements using a high vacuum technique. Starting elements are etched to remove surface oxidation and introduced into silica tubes connected to a high vacuum line. Specific elements are heated in situ to sublime high vapor pressure oxide contaminants such as SeO. The glass is then purified by distillation as described in FIG. 3.

In the illustrated embodiment of FIG. 3, silica fiber tube 302 is divided into two temperature zones: high temperature zone 304 and low temperature zone 306. Silica fiber tube 302 further comprises a small silica connecting tube 308 connecting zone 304 and zone 306. To purify the glass, the glass 310, containing metal sulfide contaminants, is placed within zone 304 of silica fiber tube 302 and inserted into furnace 314. When zone 304 is heated to between 700 and 1000 degrees C., glass 310 vaporizes and flows from zone 304 to zone 306 via connecting tube 308. As zone 306 is kept between 200-400 degrees C., the vapor then solidifies within zone 306 on the walls of silica fiber tube 302. Because vapor pressure of the metal sulfides is lower than that of the glasses, the impurities in glass 310 is left in zone 304.

As will be appreciated by one of ordinary skill in the art, the purification process described above may be repeated until satisfactory purity is obtained. In certain embodiment satisfactory purity is obtained when the attenuation of the resulting fiber is 0.1 dB/m.

As one of ordinary skill will also appreciate, there are various methods of purifying glass for use in optical fibers. Any known method of purifying glass may be used without departing from the scope of the present invention.

In certain embodiments, Applicants' hybrid fiber is fabricated using the rod-in-tube technique. In certain embodiments, the hybrid fiber is fabricated using a double crucible method, three crucible method, or other methods. As will be known by one of ordinary skill in the art, optical fibers are typically made by heating and drawing a portion of an optical preform comprising a solid glass rod with a refractive glass core surrounded by a protective glass cladding. The glass cladding is formed on the glass core using the rod-in-tube technique whereby an overclad tube is collapsed around the core. FIG. 2 depicts a diagram of an exemplary preform 200 of Applicants' hybrid fiber wherein external cladding tube 206 is collapsed around glass core 202 and cladding glass 204 to form preform 200.

The drawing process for Applicants' hybrid fiber is done on a fiber drawing tower. Preferably, the fiber drawing is performed under an atmosphere of high purity Argon gas to ensure that oxidation does not occur during the fiber drawing process as oxidation increases the attenuation in the infrared wavelengths.

Because of the higher mechanical strength of Applicants' hybrid fiber as compared to prior art mid-infrared transmissive fiber, the ends of Applicants' hybrid fiber can be mechanically polished and a fiber cable assembled. Further, Applicants' hybrid fiber is much less toxic than typical infrared fibers, such as chalcogenide glass fibers, due to the surrounding layer of external oxide glass of Applicants' hybrid fiber. Not only is the total amount of toxic material reduced with Applicants' hybrid fiber, but also the toxic materials are not directly exposed unless the external glass cladding layer corrodes.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

While the preferred embodiments of the present invention have been illustrated in detail, it should be apparent that modifications and adaptations to those embodiments may occur to one skilled in the art without departing from the scope of the present invention as set forth in the following claims.

We claim:

1. A mid-infrared transmitting glass fiber comprising:
a non-oxide infrared transmitting glass core; and
an oxide glass cladding.

2. The mid-infrared transmitting glass fiber of claim 1, wherein the non-oxide infrared transmitting glass core is transmissive from 1 to 20 microns.

3. The mid-infrared transmitting glass fiber of claim 1, wherein the non-oxide infrared transmitting glass core is selected from the group consisting of chalcogenide glass and fluoride glass.

4. The mid-infrared transmitting glass fiber of claim 3, wherein the chalcogenide glass comprises a chalcogenide element selected from the group consisting of:
As;
Ge;
Sb;
P;
Te;
Se; and
S.

5. The mid-infrared transmitting glass fiber of claim 4, wherein the chalcogenide glass is As₂S₃.

6. The mid-infrared transmitting glass fiber of claim 1, wherein the oxide glass cladding is selected from the group consisting of:
a silicate glass;
a phosphate glass;
a germanate glass;
a tellurite glass;
a borate glass;
an aluminate glass; and
a bismuth glass.

7. The mid-infrared transmitting glass fiber of claim 1, wherein a cross-section area of the oxide glass cladding is between 5% and 95% of a total cross-section area of the multicomponent glass fiber.

8. The mid-infrared transmitting glass fiber of claim 1, wherein the non-oxide infrared transmitting glass core has been purified.

9. A mid-infrared transmitting glass fiber comprising:
a non-oxide infrared transmitting glass core;
a non-oxide infrared transmitting glass inner cladding; and
an oxide glass external cladding.

10. The mid-infrared transmitting glass fiber of claim 9, wherein the non-oxide infrared transmitting glass core is transmissive from 1 to 20 microns.

11. The mid-infrared transmitting glass fiber of claim 9, wherein the non-oxide infrared transmitting glass core is selected from the group consisting of chalcogenide glass and fluoride glass.

12. The mid-infrared transmitting glass fiber of claim 11, wherein the chalcogenide glass comprises a chalcogenide element selected from the group consisting of:
As;
Ge;
Sb;
P;
Te;
Se; and
S.

13. The mid-infrared transmitting glass fiber of claim 12, wherein the chalcogenide glass is As₂S₃.

14. The mid-infrared transmitting glass fiber of claim 9, wherein the oxide glass cladding is selected from the group consisting of:
a silicate glass;
a phosphate glass;
a germanate glass;
a tellurite glass;
a borate glass;
an aluminate glass; and
a bismuth glass.

15. The mid-infrared transmitting glass fiber of claim 9, wherein a cross-section area of the oxide glass cladding is between 5% and 95% of a total cross-section area of the multicomponent glass fiber.

16. The mid-infrared transmitting glass fiber of claim 9, wherein the non-oxide infrared transmitting glass core and non-oxide infrared transmitting glass inner cladding has been purified.
